(19) United States
(12) Patent Application Publication
(10) Pub. No.: US 2008/0296990 A1
(43) Pub. Date: Dec. 4, 2008

(54) Arrangement of Rotor Laminations of a Permanently Excited Electrical Machine

(76) Inventor: Steven Andrew Evans, Buehl (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/094,560

(22) PCT Filed: Nov. 15, 2006
(86) PCT No.: PCT/EP2006/068497

§ 371 Date: May 21, 2008

(30) Foreign Application Priority Data
Nov. 21, 2005 (DE) 102005055342.7
Feb. 15, 2006 (DE) 102006006882.3

(51) Int. Cl. H02K 1/27

(52) U.S. Cl. 310/156.56

(57) ABSTRACT

The invention is based on an electrical machine having a rotor rotatably mounted about an axis of rotation and a stator. The rotor has at least one permanent magnet. The rotor has alternating field-focusing and field-free regions in its rotor body which are parallel to the axis of rotation.

### PRIOR ART

The invention is based on electrical machine on an electrical machine as generically defined by the preamble to claim 1 and a rotor as generically defined by the preamble to claim 7.

From International Patent Disclosure WO 03/005531 A1, an electrical machine is known in which permanent magnets are let into its rotor. Such so-called buried permanent magnets in the rotor have a great number of advantages for the operation of electrical machines, but these are diminished by the disadvantage that the magnetic flux in the bridges of the rotor lamination sheets is short-circuited between the permanent magnets and thus cannot be utilized. This short-circuited magnetic flux cannot overcome the air gap between the rotor and the stator and can therefore not couple into the stator windings in order to generate torque. The result is a reduction in the air gap flux per pole and consequently a reduction in the attainable torque of the electrical machine.

### Advantages of the Invention

An electrical machine is proposed, having a rotor that is supported rotatably about an axis of rotation and a stator in which the rotor has at least one permanent magnet, and the rotor, in its rotor body, has alternatingly field-focusing and field-free regions along the axis of rotation. As a result, in the field-focusing region of the rotor, the flux density is increased markedly, and the magnetic flux loss caused by short circuiting in the bridges is reduced. As a general rule, in designing such electrical machines, the magnetic circuit is designed in such a way that wherever possible in the open circuit, or in other words in the absence of the reaction field of the phase windings of the stator, a flux density of approximately 1.6 Tesla should be attained so that the lamination packet from which the rotor is constructed can be magnetically fully utilized with an additional reaction field. A typical steel that is conventionally used for the laminations has a saturation flux density of 2.1 Tesla, for instance. If the rotor is constructed conventionally, then in the rotor region where according to the invention the axially alternatingly arranged field-focusing and field-free regions are located, a flux density develops that is markedly less than what can be attained with the alternating arrangement in the field-focusing region. This means that in the conventional arrangement, the lamination sheet is not fully utilized in terms of its magnetic properties. If this region is located at the edge of the rotor, this magnetically unutilized material not only disadvantageously contributes to the mass of the rotor but also represents a significant proportion of the moment of inertia, which is proportional to the fourth power of the rotor radius.

In a favorable feature, the field-focusing regions and the field-free regions are located radially between the at least one permanent magnet and the rotor circumference on the side toward the stator. Regions which compared to a conventional rotor body with at least one buried permanent magnet have a markedly increased flux density, for instance increased by from 70 to 100%, are considered to be field-focusing regions of the rotor body. Regions that are field-free or nearly field-free are considered to be field-free regions. The field-free regions are preferably formed by air gaps, in which material is removed from the laminations, for instance, and thus the mass is reduced in an outer region of the rotor body, which typically forms the pole pieces. The field-focusing regions, conversely, are preferably formed by magnetically conductive material, such as lamination sheet material.

The rotor body is constructed for instance of sheet-metal laminations. In a favorable feature, the rotor body is formed by at least two types of alternating lamination sheets, which are stacked on one another in the direction of the axis of rotation. Thus simple manufacture of a preferred rotor can be done by advantageously employing the conventional mode of constructing laminations in order to embody the alternating arrangement of field-focusing and field-free regions.

In a favorable feature, the one type of lamination sheets (hereinafter also called the second lamination sheet type) is located in terms of its dimensions at least partially radially within the other type of lamination sheets (hereinafter also called the first lamination sheet type), because the second lamination sheet type at least partially has a lesser radial extent than the first lamination sheet type. The result is very simple implementation of the field-focusing and field-free regions. Preferably, the field-focusing region is formed by lamination sheet material. The field-free region can be formed by an air gap, extending in the axial direction, between two lamination sheets. Expedient lamination thicknesses are in the range of at most 1 mm, and preferably from 0.35 mm to 0.65 mm, for instance around 0.5 mm. Thicker laminations, in such electrical machines with permanent magnets buried in the rotor, are generally less well suited. The field-free region preferably has an axial extent of at most 1.3 mm, and especially preferably at most 1 mm. A greater axial extent is no advantage, because of the overly large air gap. The field-focusing region likewise preferably has an axial extent of at most 1.3 mm, and especially preferably at most 1 mm. In principle, the axial extent of the field-focusing region can be selected arbitrarily. A greater axial extent, however, is not advantageous for the present invention, since the reduction in the rotor mass and hence the rotor inertia is too slight. By means of the preferred feature, the magnetic properties of the lamination sheet in the field-focusing region are utilized markedly better, while the moment of inertia of the rotor is decreased by the lack of lamination material that forms the field-free regions in the form of the air gap.

In a favorable feature, the smaller lamination sheet, that is, the second lamination sheet type, with its outer circumference and with the permanent magnet inserted adjoins the at least one permanent magnet. This means that when there is more than one permanent magnet, the second lamination sheet type, in its radial extent, adjoins at least one permanent magnet. The second lamination sheet type, when there is a plurality of permanent magnets, can also adjoin a plurality of permanent magnets and preferably all of them, in this way, the second lamination sheet type, in at least one region or in a plurality of regions, has a lesser radial extent than the first lamination sheet type. In that case the second lamination sheet type has a regular, preferably rotationally symmetrical, or irregular shape. With this geometry, the weight of the rotor can be reduced and the magnetic properties of the rotor can be optimized.

The rotor body may also be constructed of more than two types of lamination sheets, in that the second lamination sheet type, which is preferably distinguished by an at least partial lesser radial extent than the first lamination sheet type, is formed by means of different lamination sheets. The different lamination sheets of the second lamination sheet type can for instance have different radial extents, or different radial extents in different regions of the lamination sheets.

Preferably, the permanent magnet is formed of material that contains neodymium-iron-boron (NdFeB) or samarium-cobalt (SmCo).

A rotor for an electrical machine is proposed in whose rotor body, supported rotatably about an axis of rotation, there is at least one permanent magnet, and in which field-focusing and field-free regions are provided in alternation along the axis of rotation.

A use of such a rotor in a brushless synchronous machine or a brushless direct current machine is proposed as well.

### DRAWINGS

Further embodiments, aspects, and advantages of the invention will become apparent, even independently of how they are summarized in claims and without restriction to their generality, from exemplary embodiments of the invention described below in conjunction with drawings. Shown in the following are:

FIGS. 1 a-c, a: a top view on a preferred electrical machine; b: a lamination of a first type; c: a lamination of a second type;

FIGS. 2 a-b, a: a detail of a longitudinal section through a preferred electrical machine; b: a detail in perspective of a preferred rotor;

FIGS. 3 a-b, a: a longitudinal detail through an electrical machine of a first alternative embodiment; b: a detail in perspective of a first alternative rotor;

FIGS. 4 a-b, a: a longitudinal detail through an electrical machine of a second alternative embodiment; b: a detail in perspective of a second alternative rotor;

FIGS. 5 a-b, a: a longitudinal detail through an electrical machine of a third alternative embodiment; b: a detail in perspective of a third alternative rotor;

FIGS. 6 a-b, a: a longitudinal detail through an electrical machine of a fourth alternative embodiment; b: a detail in perspective of a fourth alternative rotor;

FIGS. 7 a-d, a: a plan view on a lamination of the first type for a consequent-pole electrical machine with three phases and four poles; b: a first embodiment of a lamination of the second type; c: an alternative embodiment of a lamination of the second type; and d: a second alternative embodiment of a lamination of the second type; and

FIG. 8, the behavior of the rotor mass, rotor moment of inertia, and air gap flux as a function of the number of poles in a three-dimensional finite-element model.

### DESCRIPTION OF THE EXEMPLARY EMBODIMENTS

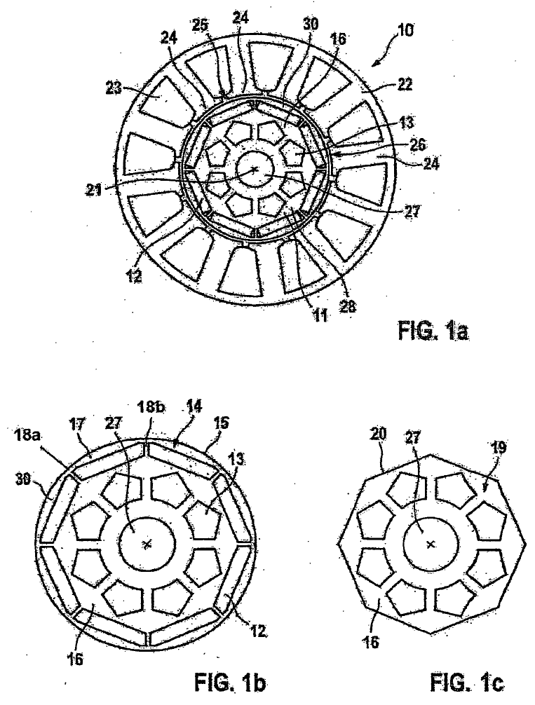

FIGS. 1a-c show the invention as an example as an electrical machine 10 embodied as a brushless synchronous machine, with three phases and eight poles, and with twelve slots 23 in the stator 22 for receiving coil windings, not shown, in which in the rotor 28 inside the rotor body 11, there are accordingly eight openings 12 for receiving permanent magnets that extend axially parallel to the axis 21 of rotation. The electrical machine 10 is embodied as an internal rotor, in which the rotor 28 is supported rotatably about the axis 21 of rotation inside the stator 22.

FIG. 1a shows a top view on the electrical machine 10. The slots 23 extending parallel to the axis 21 of rotation are separated by typical stator teeth 24, whose tooth heads are spaced apart in the usual way from one another in the middle of the slots 23 by a small air gap 25 each. Between the stator 22 and the rotor 28, an air gap 26 is embodied radially.

The rotor 28, beginning at its inner opening 27 for receiving a shaft, not shown, has eight material recesses 13, distributed symmetrically in an inner region 16 on a common radius, which reduce the mass and moment of inertia of the rotor 28. Radially spaced apart from the outer edge 15, there are eight magnet receptacles of trapezoidal cross section, which are formed by the openings 12 in the individual laminations. The core of the rotor 28 is formed by the inner region 16, and the outer region 30 of the rotor 28 is located radially outward, including the openings 12.

FIGS. 1b and 1c show preferred laminations 14, 19 of two different types, which are preferably stacked in alternation on one another (lamination 14−lamination 19−lamination 14−lamination 19−lamination 14−lamination 19, etc.) and thus form the rotor body 11 of the rotor 28. In FIG. 1b, there is a pole piece 17 in the outer region 30 between each of the openings 12 and the outer edge 15. Bridges 18a and ribs 18b are located between the openings 12. In this region, in a conventional embodiment of an electrical machine 10, the unwanted short circuits of the magnetic field lines could be observed, which in each case includes the direct peripheral regions of two adjacent openings 12, bridges 18a, and the narrow ribs 18b located between them. Typically, the short circuit encompasses a few millimeters. The curved pole pieces 17 on the outer circumference 15, the bridges 18a, and the ribs 18b are preferably as narrow as possible and at their narrowest point are equivalent for instance approximately to the thickness of the lamination 14, while their height in the middle of the pole pieces 17 is markedly greater. The height, because of geometry, depends for instance on the number of poles of the electrical machine 10.

The effects of such short circuits are advantageously lessened if one lamination 14 of the first type shown in FIG. 1b and one lamination 19 of the second type shown in FIG. 1c are stacked on one another in alternation until a desired axial length of the rotor body 11 is reached. The laminations 19 of the second type are located with their dimensions radially inside the first type of lamination sheets 14, and the laminations 19 protrude with their outer edge 20 as far as the radially inner edge of the openings 12. The laminations 19 have their inner region 16 embodied identically to the laminations 14, but the outer region 30 is missing.

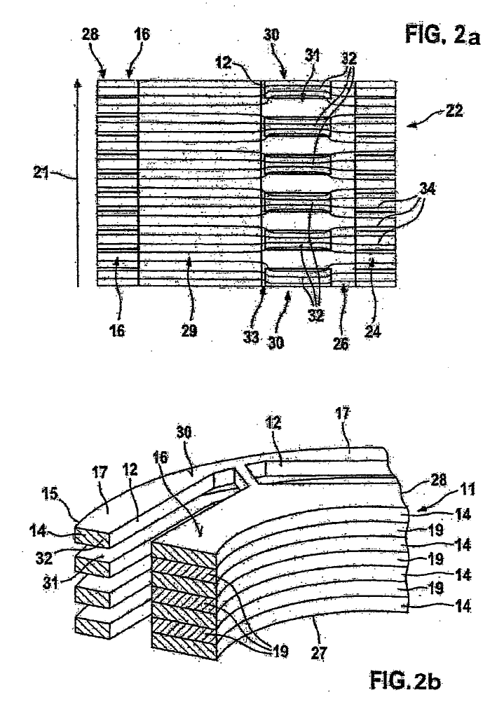

FIG. 2a shows a detail of the electrical machine 10 of FIG. 1 as a longitudinal section through the rotor 28 and the stator 22; the effect of the proposed preferred alternating arrangement of the laminations 14, 19 can be clearly seen. Reference numerals remain the same throughout the drawings for the same elements. The field lines 34, in the detail shown, extend perpendicular to the axis 21 of rotation and pass through the permanent magnet 29, the rotor 28, and the stator 22. The field lines 34 extend horizontally through the tooth head 24 of the stator 22, via the air gap 26 between the stator 22 and the rotor 28, to the outer region 30 of the rotor 28, in which the different types of laminations 14 and 19 are stacked in alternation on one another parallel to the axis 21 of rotation. The field-focusing regions 32 focus the field lines 34, while practically no field lines extend in the field-free regions 31. The field-free regions 31 are embodied as air gaps and are the result of the missing lamination sheet material, compared to the laminations 14, of the laminations 19 in the outer region 30 of the rotor 28. The height of the field-free regions 31 is equivalent to the thickness of the laminations 19. Between the regions 31, 32 and the magnet receptacle that is formed by the openings 12 located axially one above the other, with the introduced permanent magnet 29, a small air gap 33 is embodied radially, resulting for instance from manufacturing variations of the openings 12 and permanent magnets 29. The permanent magnet 29 is penetrated homogeneously by the field lines 34, which then enter the inner region 16 of the laminations 19 and 14.

FIG. 2b shows a perspective view of the rotor 28 with magnet receptacles formed by openings 12 in its rotor body 11. The preferred alternating arrangement of laminations 14 and 19 in the outer region 30 of the rotor 28 can be seen clearly; the pole pieces 17 of the laminations 14 form the field-focusing regions 32, and the air gaps between each two laminations 14 spaced apart by one lamination 19 form the field-free regions 31 as in FIG. 2a.

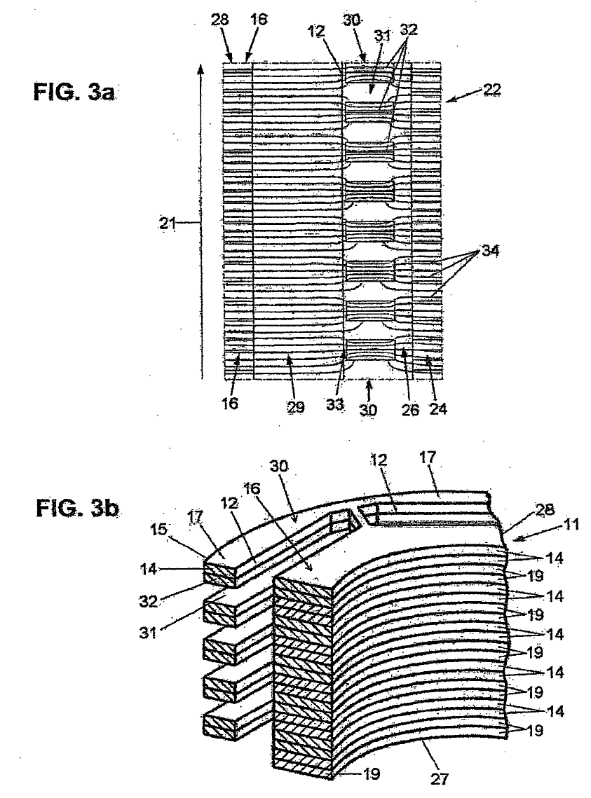

FIGS. 3a-b show an alternative composition of the laminations 14 and 19, in which two laminations of the first type 14 and two laminations of the second type 19 are arranged in alternation. This layout can be used for instance when laminations with a thickness of 0.5 mm at most, and for instance 0.35 mm, are employed. With these thinner laminations, two laminations 14 together can be used to create one mechanically stable field-focusing region 32, which has a thickness of 0.7 mm, for instance, instead of 0.35 mm. As in the embodiment of FIG. 2, the proportion of laminations 19 to the total number of laminations (that is, laminations 14+laminations 19) is 50%. This composition results in a field-free region 31 with a height of 0.7 mm, for instance, which still generates an adequate magnetic circuit. In general, the height (alternatively also called the axial extent) of the field-free regions 31 should be as small as possible and preferably no greater than 1.3 mm, and in particular no greater than 1 mm. The reduction in the rotor mass and rotor inertia and the increase in air gap flux per pole in this embodiment are largely identical to the layout of FIGS. 2a-b. The mechanical time constant and the dynamic properties of the electrical machine 10 will likewise be largely identical to the layout of FIGS. 2a-b.

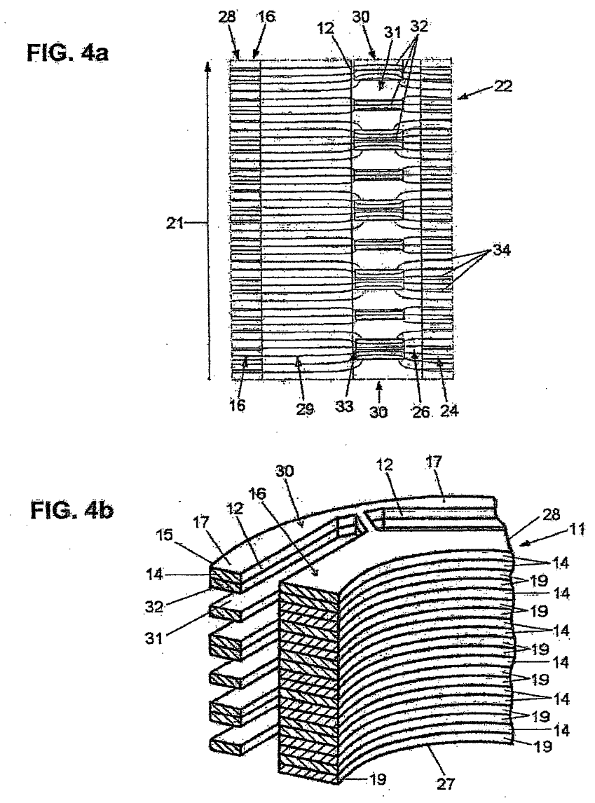

FIGS. 4a-b show a second possible alternative composition of the rotor body 11 comprising laminations 14 and 19, in which the axial extent of the field-focusing regions 32 differs. This layout is similar to the layout of FIGS. 3a-b, with the exception that the field-focusing regions 32 are formed in alternation by one or two laminations 14. FIG. 4a shows the field lines 34 in a detail of the electrical machine 10 that has this composition. From FIG. 4a it can be seen that this layout is capable of focusing all the field lines 34 of the permanent magnet 29. The proportion of laminations of the second type 19 to the total number of laminations (that is, laminations 14+laminations 19) amounts to 57%. This higher proportion leads to a further reduction in the rotor mass, the rotor inertia, and the mechanical time constant, which leads to further improvement in the dynamic properties of the electrical machine.

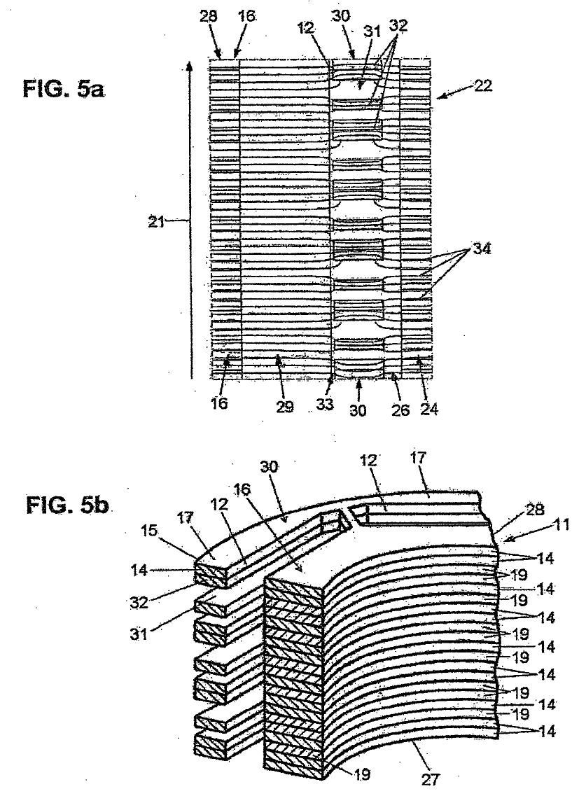

FIGS. 5a-b show a third possible alternative composition of the laminations 14 and 19, in which the height or axial extent of the field-free regions 31 differs. This layout is similar to that of FIGS. 4a-b, with the exception that the field-free regions 31 are formed in alternation by one or two laminations 19. FIG. 5a shows the field lines 34 in a detail of the electrical machine that has this composition. From this drawing it can be seen that this layout is capable of focusing all the field lines 34 of the permanent magnet 29. The proportion of laminations 19 to the total number of laminations (laminations 14+laminations 19) is 50% and is identical to the preferred layout in FIGS. 2a-b. The reduction in the rotor mass and rotor inertia and the increase in the air gap flux per pole will be largely identical to the layout in FIGS. 2a-b. The mechanical time constant and the dynamic properties of the electrical machine 10 will likewise be largely identical to the layout in FIGS. 2a-b.

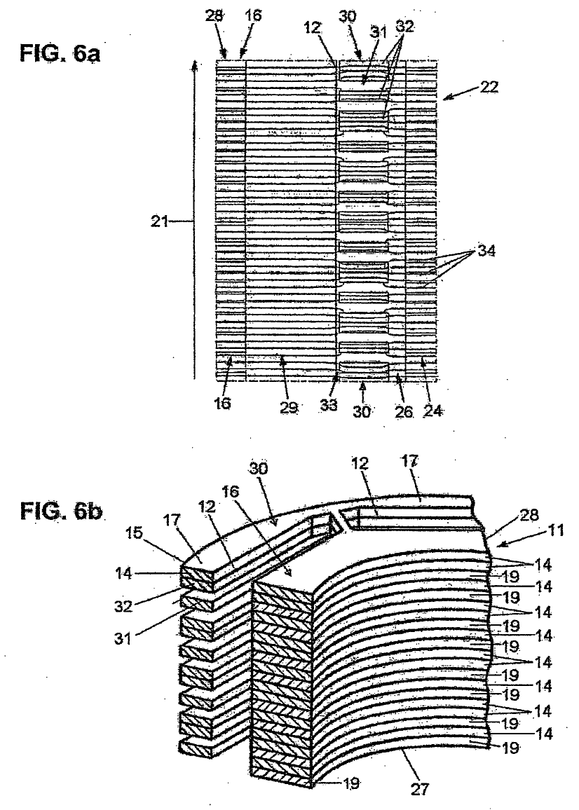

FIGS. 6a-b show a fourth possible alternative composition of the laminations 14 and 19. This layout has a composition in which the field-free regions 31 overall make up 40% and the field-focusing regions 32 make up 60% of the total number of laminations (laminations 14+laminations 19). This means that in this embodiment, more laminations of the first type 14 than laminations of the second type 19 are provided, compared to the embodiments described above. The field-free regions 31 are each formed by one lamination 19, while the field-focusing regions 32 are constructed in alternation of one or two laminations 14. This layout could be advantageous for instance if the stator 22 of the electrical machine 10 has a very large armature cross field and a small air gap 26. Under these conditions, the field-focusing regions 32 in FIGS. 2 through 5 would reach saturation. High saturation of the field-focusing regions 32 should be avoided, since that leads to a reduction in the difference between q- and d-axis reactants, which in turn can lead to a reduction in the reluctance torque that the electrical machine 10 can generate. This fact causes a reduction in the total torque of the electrical machine 10 and should therefore be avoided. The layout of FIG. 6 is associated with a lesser reduction in the rotor mass and rotor inertia, compared to the layouts of FIGS. 2 through 5.

Further features of the rotor body with laminations of the first and second types are conceivable in order to attain properties that are similar to the preferred layout in FIGS. 2a-b. The axial extent of a field-free region 31 should preferably be at most 1.3 mm, and especially preferably at most 1 mm; preferably, each field-free region 31 can be formed by one or more laminations of the second type (for instance, a lamination 19 that is 0.5 mm or 0.65 mm thick, or two laminations 19 that are each 0.35 mm thick). The field-focusing regions 32 may comprise one or more laminations of the first type 14. The number of laminations 14 used will affect the rotor mass, rotor inertia, and air gap flux per pole of the electrical machine 10 and can be selected such that the electrical machine 10 has the desired dynamic properties. In particular, the number of laminations with field-free regions (laminations of the second type) will be selected such that their proportion of the total number of laminations (that is, laminations with field-free regions and laminations with field-focusing regions) amounts to from 30 to 70%.

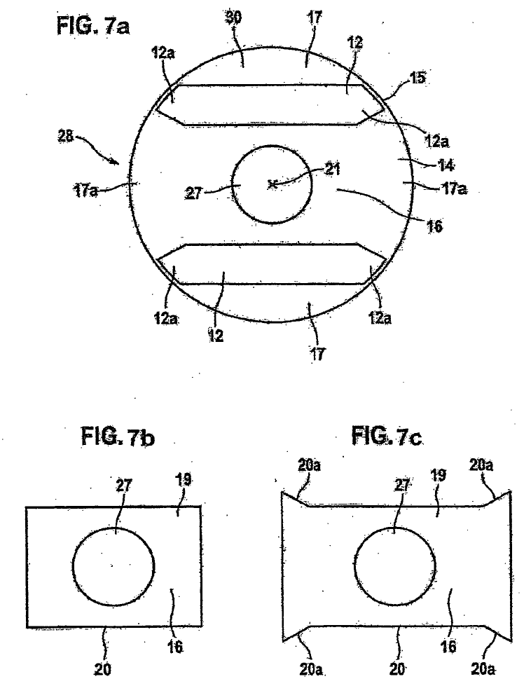

FIGS. 7a-d show a plan view on a first type of lamination 14 for a consequent-pole electrical machine, not shown, with three phases and four poles, along with alternative embodiments of laminations 19 of the second type (FIGS. 7b, 7c, 7d).

In its state, the electrical machine has six slots for coil windings and six stator teeth. The preferred rotor 28 has laminations 14, which in the outer region 30 have two diametrically opposed elongated openings 12 on the circumference, which in the stack of laminations 14, 19 form magnet receptacles for permanent magnets. On their two narrow ends 12a, oriented toward the outer circumference 15, the openings 12 taper to a point. On the outer circumference, pole pieces 17 are embodied along the openings 12, and pole pieces 17a are embodied between the openings 12.

The rotor 28 furthermore has laminations 19, which are embodied identically to the inner region 16 of the rotor 28. In a first preferred embodiment, these laminations 19 are embodied in rectangular form (FIG. 7b). Alternatively, these laminations 19 may be embodied with widened portions 20a on two ends (FIG. 7c), so that the cross section of the laminations 19 is greater than in the exemplary embodiment of FIG. 7b and is adapted even more closely to the course of the inner region 16 between the two openings 12 having the ends 12a and is complementary to the course of the openings 12 having the ends 12a. The cross section of the laminations 19 may also be rounded in the region of the pole pieces 17a and adapted to the contour of the laminations 14 (FIG. 7d). In these alternatives, some of the soft magnetic pole pieces 17a are favorably enclosed in the cross section, in order to avoid air gap flux losses from saturation, if a flux density of more than 0.9 Tesla in a conventional layout (lamination packet with only laminations 14) exists in this region.

As a result of the preferred alternating arrangement of the laminations 14 and 19, 50% of the pole pieces 17, 17a in the rotor 28 are omitted, as shown in FIG. 2b, for example. Thus the lost short-circuited magnetic stray flux—in the conventional embodiment of the laminations—is also eliminated to approximately 50%. The reduction in the stray flux thus increases the magnetic flux in the air gap 26 (FIG. 1a, FIG. 2a), and as a result the torque is increased because of the magnetic alignment of the electrical machine 10. Moreover, because of the smaller surface area of the laminations 19, the mass and moment of inertia of the rotor 28 and electrical machine 10 are reduced. With the reduction of the moment of rotor inertia and the increase in the air gap flux, the mechanical time constant (for instance, the time constant on starting) of the electrical machine is also significantly lowered. The mechanical time constant is known to be proportional to the moment of inertia of the rotor 28 and inversely proportional to the air gap flux per pole of the electrical machine 10. Accordingly, the dynamic properties of the electrical machine 10 are improved as well.

By means of three-dimensional finite element analyses, the electrical machine 10 can be modeled; this was done taking as an example a synchronous machine, embodied as an eight-pole internal rotor, with three phases, twelve stator teeth, and eight magnet receptacles for NdFeB permanent magnets in the rotor 28.

Compared with a conventional machine, whose rotor is embodied with a lamination packet comprising identical laminations 14, a preferred electrical machine 10 with an alternative arrangement of laminations 14 and laminations 19 has improved data.

If the conventional machine has a rotor stray flux of 100%, an air gap flux per pole of 100%, a rotor mass of 100%, and a moment of rotor inertia of 100%, then the values for the preferred electrical machine 10 are a rotor stray flux 54%, an air gap flux per pole of 104.5%, a rotor mass of 93.8%, and a moment of rotor inertia of 87.7%.

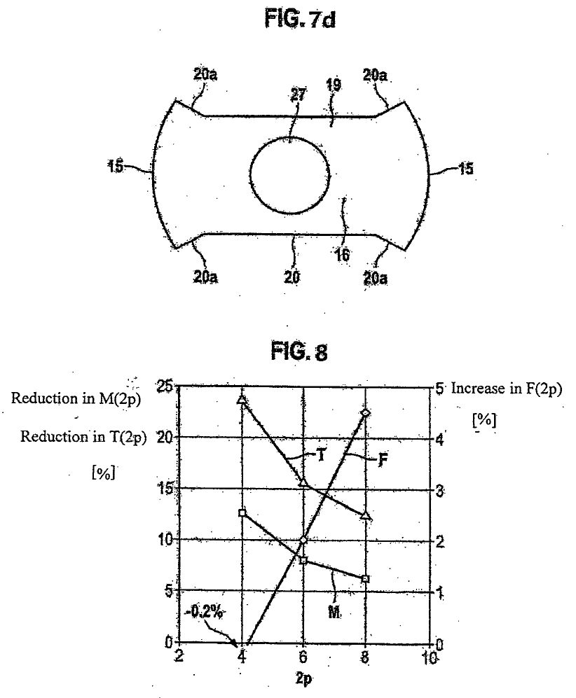

In comparable electrical machines 10 having four, six or eight poles, it is found that the maximum height in the center of the curved pole piece 17 (FIG. 1b) is inversely proportional to the number of poles; for instance, from approximately 5 mm for four poles to approximately 2.5 mm for six poles, the height drops to barely 2 mm for eight poles. In rotors 28 for four-pole or six-pole electrical machines 10, the rotor mass M, the moment of rotor inertia T, and the mechanical time constant are reduced even more markedly than in the example of the eight-pole electrical machine 10. This is shown in FIG. 8 in terms of the course of the rotor mass M(2p), the rotor moment of inertia T(2p), and the air gap flux per pole F(2p) as a function of the number of poles 2p. The four-pole electrical machine with the preferred alternating lamination arrangement has a reduction in rotor mass M of more than 12% and a reduction in the moment of rotor inertia T of more than 23%. The air gap flux F, at approximately 0.2%, is less than with a conventional lamination packet as a rotor, and this indicates that a four-pole embodiment of the electrical machine 10 expediently represents the least number of poles for a practical application of the invention.

1-10. (canceled)

11. An electrical machine comprising
a rotor supported rotatably about an axis of rotation and a stator, wherein the rotor includes a rotor body and at least one permanent magnet, the rotor body having alternating field-focusing and field-free regions parallel to the axis of rotation.

12. The electrical machine according to claim 11, wherein the field-focusing regions are disposed radially between the at least one permanent magnet and a circumference of the rotor on a side of the rotor oriented toward the stator.

13. The electrical machine according to claim 11, wherein the field-free regions are formed by air gaps.

14. The electrical machine according to claim 12, wherein the field-free regions are formed by air gaps.

15. The electrical machine according to claim 11, wherein the field-focusing regions are formed by lamination sheet material.

16. The electrical machine according to claim 12, wherein the field-focusing regions are formed by lamination sheet material.

17. The electrical machine according to claim 13, wherein the field-focusing regions are formed by lamination sheet material.

18. The electrical machine according to claim 11, wherein the rotor body is formed by at least two types of lamination sheets, which are stacked on one another in the direction of the axis of rotation.

19. The electrical machine according to claim 12, wherein the rotor body is formed by at least two types of lamination sheets, which are stacked on one another in the direction of the axis of rotation.

20. The electrical machine according to claim 13, wherein the rotor body is formed by at least two types of lamination sheets, which are stacked on one another in the direction of the axis of rotation.

21. The electrical machine according to claim 15, wherein the rotor body is formed by at least two types of lamination sheets, which are stacked on one another in the direction of the axis of rotation.

22. The electrical machine according to claim 18, wherein the at least two types of lamination sheets are stacked on one another in alternation in the direction of the axis of rotation.

23. The electrical machine according to claim 18, wherein the one second type of lamination sheets in terms of its dimensions is located radially inside the first type of lamination sheets.

24. The electrical machine according to claim 22, wherein the one second type of lamination sheets in terms of its dimensions is located radially inside the first type of lamination sheets.

25. The electrical machine according to claim 23, wherein the second type of lamination sheet being radially smaller than the first type of lamination sheet, has its outer circumference, with the permanent magnet inserted, adjoining the at least one permanent magnet.

26. The electrical machine according to claim 24, wherein the second type of lamination sheet being radially smaller than the first type of lamination sheet, has its outer circumference, with the permanent magnet inserted, adjoining the at least one permanent magnet.

27. A rotor for an electrical machine having at least one permanent magnet located in a rotor body of the rotor that is rotatably supported about an axis of rotation and having alternating field-focusing and field-free regions disposed in the rotor body, parallel to the axis of rotation.

28. A rotor according to claim 27, disposed in a brushless synchronous machine or a brushless direct current machine.
